(19) United States
(12) Patent Application Publication
(10) Pub. No.: US 2007/0019393 A1
(43) Pub. Date: Jan. 25, 2007

(54) DUAL DISPLAY STRUCTURE

(76) Inventor: Ming-Hung Tsai, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/163,813

(22) Filed: Oct. 31, 2005

(30) Foreign Application Priority Data
Jul. 22, 2005 (TW) 094124921

(51) Int. Cl. G01D 11/28

(52) U.S. Cl. 362/26; 362/602; 362/632

(57) ABSTRACT

A dual display structure has a back light module, a first display panel deposited on one side of the back light module, a housing for putting and fixing the back light module and the first display panel, and a second display panel. The housing has a firm plate having a light exit opening. The back light module is disposed on a first firm surface of the firm plate, and the first firm surface has a gray face for absorbing the emitted light from the back light module that can make uniform light of the whole back light module. The second display panel is disposed on a second firm surface of the firm plate, and the back light module provides light through the light exit opening to the second display panel.

### BACKGROUND OF THE INVENTION

1. Field of the Invention

The present invention relates to a dual display structure, and more particularly, to a dual-panel LCD to prevent a shadow of a main display panel.

2. Description of the Prior Art

The LCD is a thin and electricity-saving flat display device. The advantages of LCDs are obvious when compared with CRT monitors. The LCD uses different liquid crystal rotation angles to control light transmittance. Brightness is controlled by transmittance. When color is constant, a liquid crystal is held at one position. Therefore, the LCD has the advantages of stable image appearance and low flickering. Moreover, LCDs are truly flat. In addition, since the LCD has very low radiation output, a user's eye will not be harmed if watching the LCD for a long time. LCDs are also small and energy efficient and as such are in great demand.

Because of the advantages mentioned above, LCDs are used in portable products such as mobile phones, PDAs, notebook computers, and digital cameras, as well as in the aerospace industry and in medical instruments. It was almost impossible to make these portable products in the era of CRT monitor. The technology of the LCD improves as new products rapidly enter the market. The latest development is a dual display LCD applied in various products. However, new developments need to be light weight, easy to assemble, stable, and durable to be welcome.

A prior art dual-display LCD is made by combining two LCD modules back to back. This method increases the weight and thickness of the end product, and therefore does not meet the demand of light, thin, and small products. Another prior art makes the dual-display LCD using parts of optical components together. When assembling a main panel and a sub panel, they are fixed on two sides of a main housing for positioning the panels. The backlight module is positioned between the main housing and the main panel, and it provides light for the sub panel via the main housing. Since a light guide plate is shared between the main panel and the sub panel, there is another problem. Some light enters the sub panel via a light-exiting opening and other light is reflected to the main panel completely by the white main housing because the sizes of the sub panel and the light-exiting opening are smaller than the main panel. Therefore there is a non-uniform distribution of light on the main panel, i.e. light at the light-exiting opening of the main housing is dim and forms a shadow on the light-exiting opening. This causes a difference of light intensity and color on the main panel.

There are some methods to improve the problems mentioned above. For example, it is possible to modify the pattern of the light guide plate in the backlight module to make the light distribution more uniform, but there is a high threshold in the critical dimension of the pattern design because some light is consumed in the rear optical source. There is still a non-uniform distribution of light, i.e. window issue, on the main panel even after fine tuning. Using diffusers can improve the window issue, but the result is not good enough. Using composite films like brightness enhancement films or diffusers to overcome the window issue substantially increases the cost and thickness of the dual-display LCD. Therefore the present invention teaches a method of overcome the window issue, reducing cost, and enhancing quality.

### SUMMARY OF THE INVENTION

The present invention relates to a dual-panel LCD structure to prevent the problem mentioned above.

The embodiment of the present invention relates to a dual display structure comprising a backlight module, a first display panel, a housing, and a second display panel. The first display panel is formed in the side of the backlight module, and the housing is used for containing the backlight module, the first display panel, and the second display panel. The housing has a firm plate having a light exit opening. The back light module is disposed on a first firm surface of the firm plate, and the first firm surface has a gray face for absorbing the emitted light from the back light module that can make uniform light of the whole back light module. The second display panel is disposed on a second firm surface of the firm plate, and the back light module provides light through the light exit opening to the second display panel.

Since the dual display structure of the present invention uses the gray face, it can reduce part of positive direction light emitted from the first firm surface of the firm plate entering the first display panel, and decrease occurrence of the window issue on the first display panel. In order to decrease occurrence of the window issue, the prior art often uses multi-layer film, e.g. brightness enhancement film and light diffuser film, to increase light brightness and reduce patchiness, but the result is not good. Therefore the dual display structure of the present invention can reduce the quantity of films to lower the cost and thickness substantially.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1, 2 are diagrams of a dual display structure according to the present invention.

FIG. 3 is an exploded diagram of a dual display structure according to the present invention.

FIG. 4 is a front diagram of a housing shown in FIG. 3.

FIG. 5 is a back diagram of a housing shown in FIG. 3.

FIG. 6 is a front diagram of a housing of another embodiment according to the present invention.

FIG. 7 is an exploded diagram of a dual display structure according to the present invention.

### DETAILED DESCRIPTION

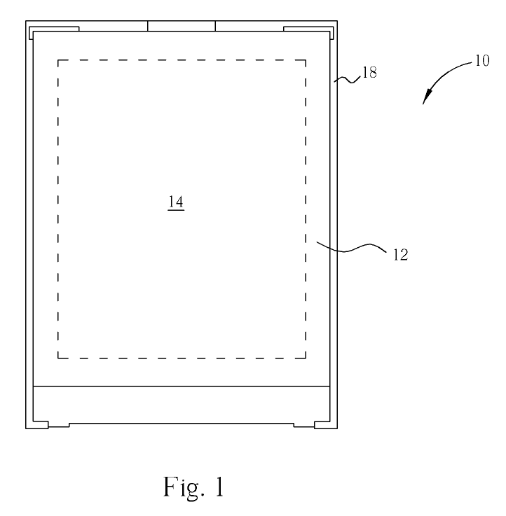

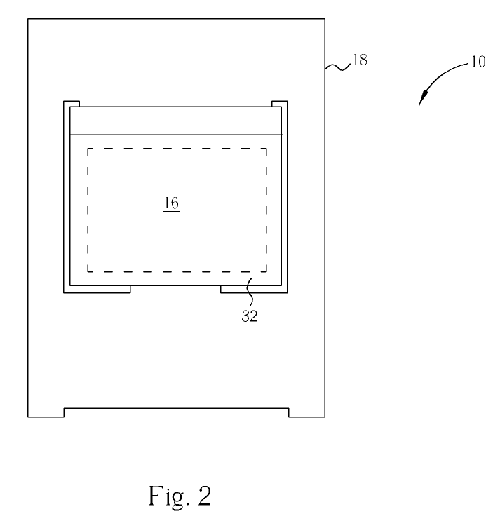

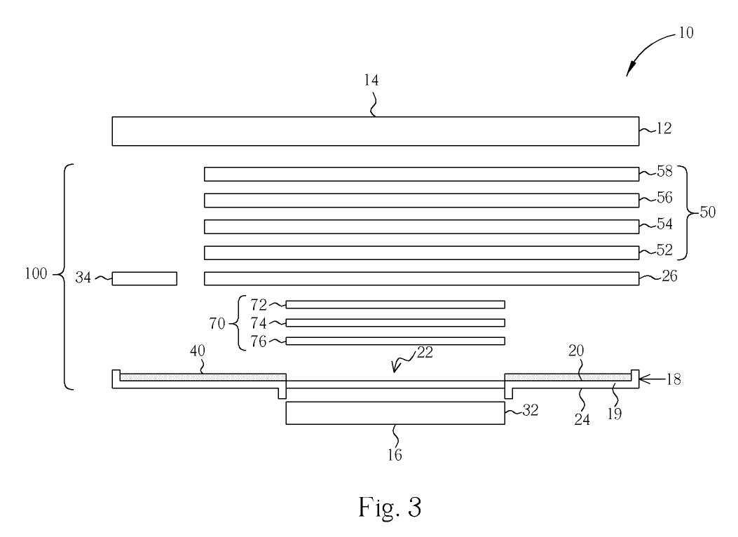

Please refer to FIGS. 1 and 2. FIGS. 1 and 2 are diagrams of a dual display structure 10 according to the present invention. As shown in FIG. 1, the dual display structure 10 of the present invention comprises a main display panel 12 which is an LCD panel, and the main display panel 12 comprises a first surface 14 which is the display face of the main display panel 12. A dashed-line area in FIG. 1 is the display area of the main display panel 12. The dual display structure 10 of the present invention also comprises a housing 18 which is used to hold and steady the backlight module 100 shown in FIG. 3 and the main display panel 12. FIG. 2 is a reverse side of the dual display structure 10 in FIG. 1. As shown in FIG. 2, the dual display structure 10 of the present invention further comprises a sub-display panel 32 which is an LCD panel, and the sub-display panel 32 comprises a second surface 16 which is the display face of the sub-display panel 32. A dashed-line area in FIG. 2 is the display area of the sub-display panel 32.

Please refer to FIG. 3. FIG. 3 is an exploded diagram of the dual display structure 10 according to the present invention. The size of the main display panel 12 is bigger than the sub-display panel 32. The backlight module 100 comprises optical mechanisms 50 and 70, a light guide plate 26, and at least a light source 34. The housing 18 has a fixing base 19 having a light-exiting opening 22, and there are one first fixing surface 20 and one second fixing surface 24 on both sides of fixing base 19 of the housing 18. The main display panel 12 is positioned on the first fixing surface 20 of the housing 18. The optical mechanisms 50 and 70 are positioned between the main display panel 12 and the first fixing surface 20. The sub-display panel 32 is positioned on the second fixing surface 24 of the housing 18. The size of the light-exiting opening 22 is approximately the same as the size of the sub-display panel 32. The optical mechanism 50 comprises a first diffuser 52, a prism sheet 54, a brightness enhancement film 56, and a second diffuser 58, and the optical mechanism 70 comprises a third diffuser 72, a prism sheet 74, and a brightness enhancement film 76. The prism sheets 54 and 74 are a kind of brightness enhancement film, so they can be termed brightness enhancement films in general. Therefore, the components of the optical mechanisms 50 and 70 can be different depending on various designs, which means all the diffusers 52, 72, the prism sheets 54, 74, and brightness enhancement films 56, 76 may be included in the optical mechanisms 50, 70, while one or more of these optical films may be omitted or others may be included in the optical mechanisms 50, 70.

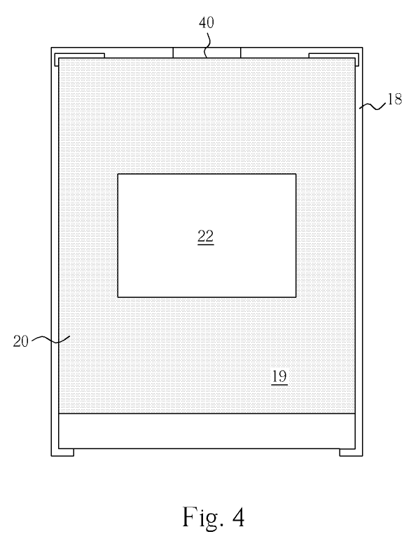

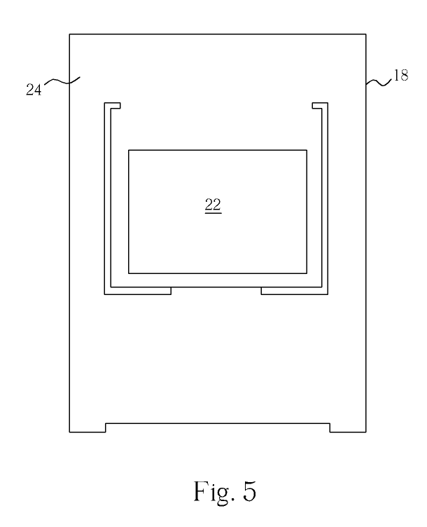

Please refer FIGS. 4 and 5. FIG. 4 is a front diagram of the housing 18 shown in FIG. 3. FIG. 5 is a back diagram of the housing 18 shown in FIG. 3. As shown in FIG. 4 there is a gray face formed by a gray film 40 or gray color on the first fixing surface 20 of the fixing base 19. As shown in FIG. 5, the reverse side of the housing 18 is the second fixing surface 24 of the fixing base 19.

When light is emitted from the LED light source 34, it comes into the light guide plate 26 first. Then, part of the light travels to one side near the main display panel 12 and spreads uniformly on the main display panel 12 by way of the optical mechanism 50. In the mean time, another part of the light travels to another side of the light guide plate 26 to the fixing base 19, and the light nearby the light-exiting opening 22 enters the sub-display panel 32 via the light-exiting opening 22 of the housing 18 and spreads uniformly on the sub-display panel 32 by way of the optical mechanism 70 to result in dual-panel display. In the prior art, light traveling to the fixing base 19 is completely reflected to the main display panel 12 by the first fixing surface 20 of the white housing 18. However, the light nearby the light-exiting opening 22 directly passes through the light-exiting opening 22 and enters the sub-display panel 32 via the optical mechanism 70. Therefore the light nearby the light-exiting opening 22 will not be reflected by the first fixing surface 20 of the white housing 18 to the main display panel 12 and will spread out a non-uniform distribution of light on the main display panel 12. This results in a shadow having a shape near the light-exiting opening 22 on the main display panel 12 which is known as the window issue. The window issue can also arise from poor design of the light guide plate 26.

Therefore, the present invention provides a gray face formed by a specific gray color or a gray film 40 on the first fixing surface 20 of the housing 18, or a gray color material for the housing 18. The gray face can absorb part of the light generated by the backlight module 100 to reduce the light reflected to the light guide plate 26 and entering the main display panel 12. The gray face can make brightness of the light provided by the backlight module 100 for the main display panel 12 similar in the light-exiting opening 22 and areas other than the light-exiting opening in order to avoid the window issue. The shape of the gray film 40 approximately matches the shape of the fixing base 19 of the housing 18, and the gray film 40 has an opening whose position and size match the light-exiting opening 22 of the fixing base 19 of the housing 18. The gray film 40 is a film with gray color which can be separated from the housing 18, or a gray coating on the housing 18.

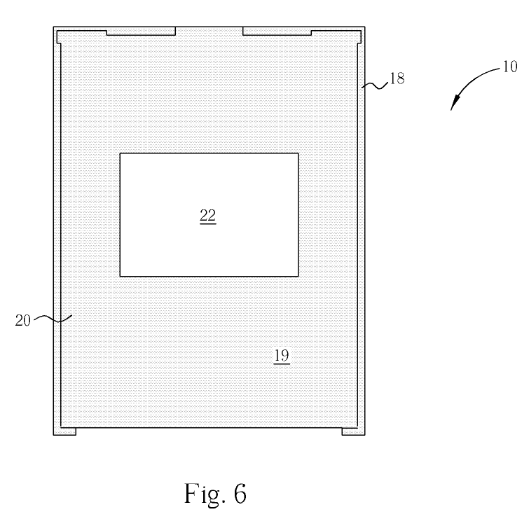

Please refer to FIG. 6. FIG. 6 is a front diagram of a housing 18 of another embodiment according to the present invention. As shown in FIG. 6, the material of the housing 18 of the dual display structure 10 according to the present invention is a gray color material. Since the housing 18 itself has a gray face, it can absorb part of the light to prevent light reflection, and therefore it can decrease cost and thickness because the gray film in FIG. 3 is not needed anymore.

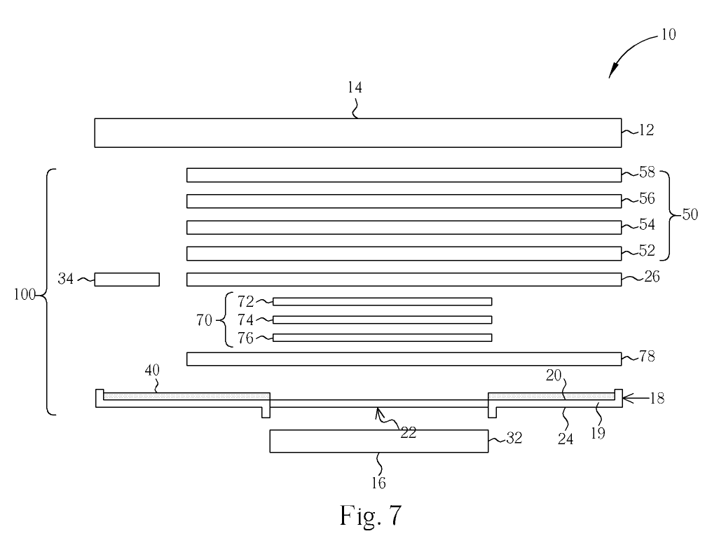

The present invention can also include a transflective film 78 between the backlight module 100 and the fixing base 19 of the housing 18 depending on specific requirements. The transflective film 78 can reflect most of the light for the main display panel 12 to increase the whole brightness of the main display panel 12 as shown in FIG. 7. The transflective film 78 can be omitted if the light source is sufficient.

The structure disclosed by the present invention is a dual display structure 10, and therefore when the structure is assembled, miscellaneous optical components must be set up between the main display panel 12 and sub-display panel 32 in order to transmit light to the display surfaces of the main display panel 12 and sub-display panel 32, i.e. the first surface 14 and the second surface 16. Since the design details of the miscellaneous optical components are not critical to the present invention, they will not be discussed further.

The present invention uses a gray face formed by a gray film 40 on the fixing base 19 of the housing 18 or a housing 18 made by gray material to absorb the light generated by the backlight module 100. This can effectively prevent the non-uniform distribution of light on the main display panel 12, the window issue, that is caused by some light is directly reflected to the main display panel 12 by the fixing base 19 but some light directly passes through the light-exiting opening 22 of the housing 18 to the sub-display panel 32.

Compared to the dual display structure of the prior art, the dual display structure according to the present invention uses a gray face formed by a gray film 40 on the first fixing surface 20 of the housing 18 or a housing 18 made of gray material to absorb the light generated by the backlight module 100. This can make the light distribution more uniform on the main display panel 12 in order to improve the window issue. The present invention can also include a transflective film 78 or other films to increase the brightness of the main display panel 12, and improve the window issue caused by poor light guide plate design. The present invention can also reduce the development time of the light guide plate, and reduce the redundant films such as brightness enhancement films or diffusers to decrease cost and the thickness of the dual display structure. Process yield also can be improved by collocating a pattern of the light guide plate.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A dual display structure comprising:
a backlight module;
a first display panel positioned at a side of the backlight module;
a housing for containing the backlight module and the first display panel, the housing comprising a fixing base having a light-exiting opening, the backlight module and the first display panel being positioned on a first fixing surface of the fixing base in order, the fixing base having a gray face that partially absorbs light generated by the backlight module so that the backlight module provides similar brightness of light to the first display panel at the light-exiting opening and not at the light-exiting opening; and
a second display panel positioned on a second fixing surface of the fixing base, the second fixing surface being opposite the first fixing surface for positioning the backlight module, the backlight module providing light to the second display panel through the light-exiting opening.

2. The dual display structure of claim 1, wherein a size of the second display panel is smaller to a size of the first display panel, and a size of the light-exiting opening is approximately equal to a size of the second display panel.

3. The dual display structure of claim 1, wherein the first fixing surface of the fixing base comprises a gray color serving as the gray face.

4. The dual display structure of claim 3, wherein a material of the housing comprises a gray color.

5. The dual display structure of claim 1, wherein the dual display structure further comprises a gray film on the first fixing surface of the fixing base, the gray film serving as the gray face.

6. The dual display structure of claim 5, wherein a size and a shape of the gray film are approximately similar to a size and a shape of the fixing base.

7. The dual display structure of claim 6, wherein the gray film comprises an opening, and a size and a position of the opening in the gray film are the same as a size and a position of the light-exiting opening in the fixing base.

8. The dual display structure of claim 1, wherein the backlight module comprises a light guide plate and at least a light source.

9. The dual display structure of claim 1, wherein the dual display structure further comprises a transflective film positioned between the backlight module and the fixing base.

10. A method for making brightness of a dual display structure uniform, wherein the dual display structure comprises:
a housing comprising a fixing base, the fixing base having a first fixing surface, a second fixing surface, and a light-exiting opening;
a backlight module positioned on the first fixing surface;
a first display panel positioned on the backlight module; and
a second display panel positioned on the second fixing surface, the backlight module providing light to the second display panel through the light-exiting opening;
the method comprising:
determining a specific gray color that is capable of absorbing a part of light generated by the backlight module so that the backlight module provides similar brightness of light to the first display panel at the light-exiting opening and not at the light-exiting opening; and
providing a gray face on the first fixing surface, the gray face having the specific gray color.

11. The method of claim 10, wherein the color of the first fixing surface is the specific gray color.

12. The method of claim 11, wherein the housing is formed with a material having the specific gray color.

13. The method of claim 10, wherein a gray film is positioned on the first fixing surface for providing the gray face.

14. The method of claim 13, wherein a size and a shape of the gray film are similar to a size and a shape of the fixing base.

15. The method of claim 14, wherein the gray film has an opening, and a size and a position of the opening in the gray film are the same as a size and a position of the light-exiting opening in the fixing base.

16. The method of claim 10, further comprising providing a transflective film positioned between the backlight module and the fixing base.

17. The method of claim 10, wherein a size of the second display panel is smaller than a size of the first display panel, and a size of the light-exiting opening is approximately equal to a size of the second display panel.
